(19) United States
(12) Patent Application Publication
(10) Pub. No.: US 2026/0213239 A1
(43) Pub. Date: Jul. 23, 2026

(54) MEMBRANE-ELECTRODE ASSEMBLY AND FUEL CELL COMPRISING SAME

(71) Applicant: KOLON INDUSTRIES, INC., Seoul (KR)

(72) Inventors: Jung Ho KIM, Seoul (KR); Jun Young KIM, Seoul (KR); Nak Won KONG, Seoul (KR); Kah Young SONG, Seoul (KR); Eun Su LEE, Seoul (KR); Hyeong Su KIM, Seoul (KR); Kyoung Sik NAM, Seoul (KR); Ju Sung LEE, Seoul (KR); Chan Mi PARK, Seoul (KR)

(21) Appl. No.: 19/140,304

(22) PCT Filed: Jun. 29, 2023
(86) PCT No.: PCT/KR2023/009141

§ 371 Date: Jun. 17, 2025

(30) Foreign Application Priority Data
Jul. 19, 2022 (KR) 10-2022-0089163

(51) Int. Cl. H01M 8/1004; H01M 4/86; H01M 4/90; H01M 8/10

(52) U.S. Cl. CPC H01M 8/1004; H01M 4/8657; H01M 4/9008; H01M 4/9083; H01M 2008/1095

(57) ABSTRACT

Provided is a membrane-electrode assembly having both improved performance and durability. One embodiment of the present invention provides a membrane-electrode assembly comprising: a polymer electrolyte membrane; a first catalyst layer disposed on at least one surface of the polymer electrolyte membrane; and a second catalyst layer disposed on the polymer electrolyte membrane, wherein the first catalyst layer is interposed between the polymer electrolyte membrane and the second catalyst layer, and the first catalyst layer includes platelet mesoporous carbon.

### TECHNICAL FIELD

The present disclosure relates generally to a membrane-electrode assembly and a fuel cell including the same. More specifically, the present disclosure relates to a membrane-electrode assembly having both improved performance and durability and a fuel cell including the same.

### BACKGROUND ART

Fuel cells are cells that directly convert chemical energy generated by oxidation of fuel into electrical energy. Fuel cells are widely considered a next-generation energy source due to their environmentally friendly features such as high energy efficiency and low pollutant emissions. Generally, a fuel cell has a structure in which a polymer electrolyte membrane is interposed between an oxidation electrode (anode) and a reduction electrode (cathode). This structure is referred to as a membrane-electrode assembly (MEA).

Fuel cells can be classified into alkaline electrolyte fuel cells and polymer electrolyte membrane fuel cells (PEMFC) depending on the type of electrolyte membrane. Of these, polymer electrolyte membrane fuel cells are gaining much attention as power supply devices for portable, automotive, and household applications due to their advantages such as low operating temperature of less than 100° C., fast starting and responding characteristics, and excellent durability.

A representative example of such polymer electrolyte membrane fuel cells is a proton exchange membrane fuel cell (PEMFC), which uses hydrogen gas as fuel.

In briefly describing the reaction that occurs in a polymer electrolyte membrane fuel cell, first, when fuel such as hydrogen is supplied to an oxidation electrode (or anode), hydrogen at the oxidation electrode is oxidized to produce protons and electrons. The protons thus produced are transferred to a reduction electrode through a polymer electrolyte membrane, whereas the electrons thus produced are transferred to the reduction electrode (or cathode) through an external circuit. Oxygen is supplied to the reduction electrode, and oxygen is reduced by combining with protons and electrons to produce water.

Conventional catalysts using platinum nanoparticles supported on carbon are expensive, and carbon carriers are prone to degradation under fuel cell operating conditions. This calls for the development of novel electrode materials. Electrode catalyst materials are generally composed of platinum-based metal catalyst particles and a catalyst carrier, and significantly increasing fuel cell performance is achievable simply by improving both the catalyst and the catalyst carrier. Therefore, there is ongoing research focused on enhancing the performance of catalyst carriers.

### DISCLOSURE

### Technical Problem

An objective of the present disclosure is to provide a membrane-electrode assembly having both improved performance and durability.

Another objective of the present disclosure is to provide a membrane-electrode assembly having improved ion conductivity and performance by having material and ion transfer channels in the form of nanopores oriented orthogonal to an in-plane direction of a polymer electrolyte membrane.

Still another objective of the present disclosure is to provide a membrane-electrode assembly including a catalyst layer having improved durability by maintaining a stable form of ion transfer path even during operation of a fuel cell.

Yet another objective of the present disclosure is to provide a fuel cell including the membrane-electrode assembly.

The objectives of the present disclosure are not limited to those mentioned above, and other objectives not mentioned and advantages of the present disclosure will be understood by the following description and become apparent from the embodiments of the present disclosure Further, it will be readily understood that the objectives and advantages of the present disclosure are realized by the means set forth in the appended claims and combinations thereof.

### Technical Solution

In order to accomplish the above objectives, according to a first aspect of the present disclosure, there is provided a membrane-electrode assembly, including: a polymer electrolyte membrane; a first catalyst layer disposed on at least one surface of the polymer electrolyte membrane; and a second catalyst layer disposed on the polymer electrolyte membrane, in which the first catalyst layer may be interposed between the polymer electrolyte membrane and the second catalyst layer, and the first catalyst layer may include platelet mesoporous carbon.

According to a second aspect of the present disclosure, in the first aspect, an ionomer layer may be coated on a surface and pores of the platelet mesoporous carbon.

According to a third aspect of the present disclosure, in the second aspect, the ionomer layer may include a first ionomer, and the first ionomer may have an equivalent weight (EW) of 600 to 1,200.

According to a fourth aspect of the present disclosure, in the third aspect, the first ionomer may be any one selected from the group consisting of a fluorine-based ionomer, a hydrocarbon-based ionomer, and a mixture thereof.

According to a fifth aspect of the present disclosure, in any one of the first to fourth aspects, the platelet mesoporous carbon may be in the form in which nanofibers or nanotubes are aligned, and pores included in the nanofibers or nanotubes may extend orthogonal to an in-plane direction of the polymer electrolyte membrane.

According to a sixth aspect of the present disclosure, in the fifth aspect, the nanofibers and the nanotubes may each independently have a height of 50 to 600 nm.

According to a seventh aspect of the present disclosure, in any one of the first to sixth aspects, the first catalyst layer may have an area of 10% to 70% with respect to the total area of the one surface of the polymer electrolyte membrane.

According to an eighth aspect of the present disclosure, in any one of the first to seventh aspects, the second catalyst layer has a thickness the same as or different from that of the first catalyst layer.

According to a ninth aspect of the present disclosure, in any one of the first to eighth aspects, the second catalyst layer may have a thickness larger than that of the first catalyst layer.

According to a tenth aspect of the present disclosure, in any one of the first to ninth aspects, the first catalyst layer may have a thickness of 50 to 2,000 nm.

According to an eleventh aspect of the present disclosure, there is provided a fuel cell including the membrane-electrode assembly of any one of the first to tenth aspects.

The foregoing technical solutions do not fully enumerate all of the features of the present inventive concepts. The foregoing and other objectives, features, aspects and advantages of the present inventive concepts will become more apparent from the following detailed description of the present inventive concepts.

### Advantageous Effects

According to an aspect of the present disclosure, it is possible to provide a membrane-electrode assembly having both improved performance and durability. Additionally, according to another aspect of the present disclosure, it is possible to provide a membrane-electrode assembly that has material and ion transfer channels in the form of nanopores oriented orthogonal to an in-plane direction of a polymer electrolyte membrane, thereby achieving improved ion conductivity and performance, and maintains a stable form of ion transfer channels through pores in platelet mesoporous carbon during operation of a fuel cell, thereby achieving improved durability even during long-term operation of a fuel cell.

Specific effects of the present disclosure as well as the above-mentioned effects will be described together below, while describing subject matters for carrying out the disclosure.

### DESCRIPTION OF DRAWINGS

FIG. 1 is a schematic view illustrating a method for manufacturing a membrane-electrode assembly according to an embodiment of the present disclosure.

FIG. 2a is a schematic view illustrating a method for manufacturing a membrane-electrode assembly according to another embodiment of the present disclosure, and FIG. 2b is a view illustrating platelet mesoporous carbon having an ionomer layer of FIG. 2a coated on a surface thereof.

FIG. 3 is a schematic view illustrating a method for manufacturing a membrane-electrode assembly according to still another embodiment of the present disclosure.

FIG. 4a is a schematic view illustrating a method for manufacturing a membrane-electrode assembly according to yet another embodiment of the present disclosure, and FIG. 4b is a view illustrating platelet mesoporous carbon having an ionomer layer of FIG. 4a coated on a surface thereof.

FIG. 5 is a schematic view illustrating a fuel cell according to an embodiment of the present disclosure.

FIG. 6 is a view illustrating ultra high resolution-scanning electron microscope (UHR-SEM) images of platelet mesoporous carbon in the form in which nanofibers are aligned according to Preparation Example 1-1.

FIG. 7 is a view illustrating ultra high resolution-scanning electron microscope (UHR-SEM) images of platelet mesoporous carbon in the form in which nanotubes are aligned according to Preparation Example 2-1.

FIG. 8 is a view illustrating SEM cross-sectional images of a membrane-electrode assembly including platelet mesoporous carbon in the form in which nanotubes are aligned according to Example 2-2.

FIG. 9 is a view illustrating the performance evaluation results of membrane-electrode assemblies manufactured by Examples and Comparative Example under conditions of 80° C., 100% RH, and normal pressure.

### MODE FOR INVENTION

Hereinbelow, each configuration of the present disclosure will be described in detail such that the present disclosure can be easily embodied by one of ordinary skill in the art to which this disclosure belongs, but this is merely one example, and the scope of the present disclosure is not limited thereto.

An embodiment of the present disclosure provides a membrane-electrode assembly including a polymer electrolyte membrane, a first catalyst layer disposed on at least one surface of the polymer electrolyte membrane, and a second catalyst layer disposed on the polymer electrolyte membrane, in which the first catalyst layer is interposed between the polymer electrolyte membrane and the second catalyst layer, and the first catalyst layer includes platelet mesoporous carbon. According to an embodiment of the present disclosure, by introducing a layer composed of platelet mesoporous carbon having vertical nanopores or platelet mesoporous carbon having an ionomer layer coated on a surface and pores thereof, material and ion transfer channels can be created in the form of nanopores oriented orthogonal to an in-plane direction of an electrolyte membrane, thereby improving ion conductivity and performance, and a stable form of ion transfer channels can be maintained through the pores in the platelet mesoporous carbon during operation of a fuel cell, thereby improving durability. According to another embodiment of the present disclosure, by utilizing metal nanoparticles supported in pores of platelet mesoporous carbon, it is possible to improve performance due to an increase in active catalysts and effectively prevent metal nanoparticles from agglomerating, thereby significantly improving catalyst durability. Also, the metal nanoparticles can act as radical scavengers, thereby significantly improving the chemical durability of catalyst layers.

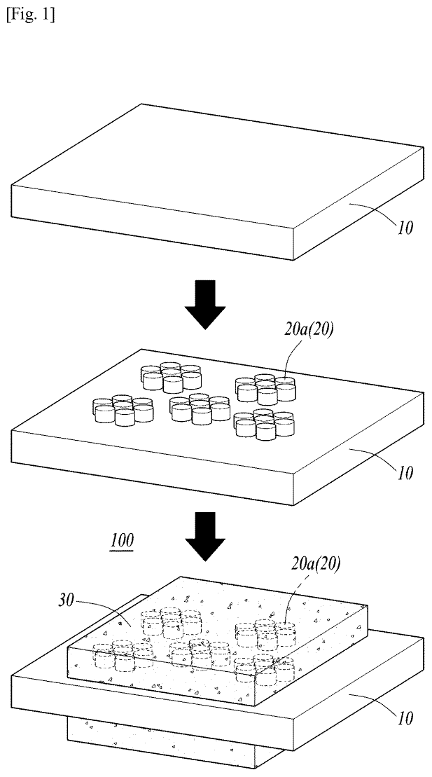

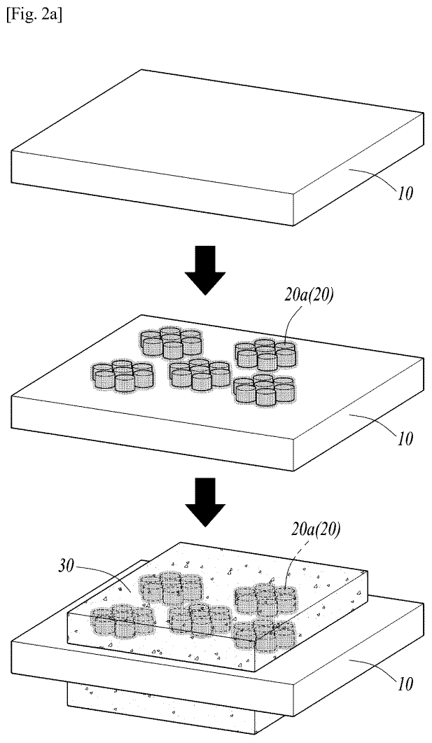

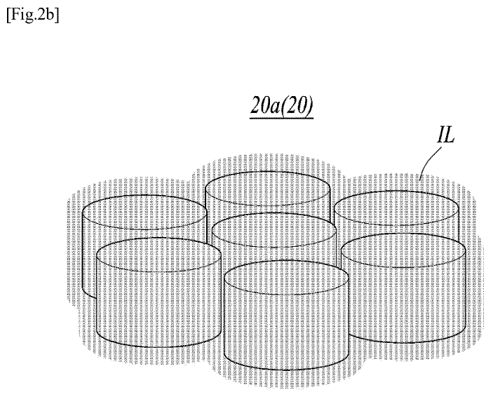

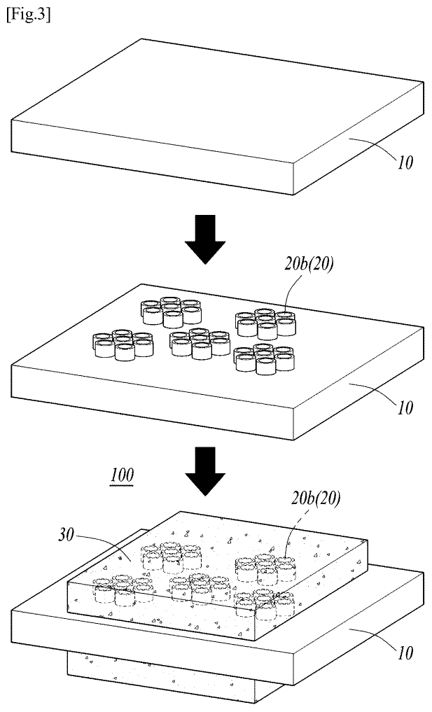

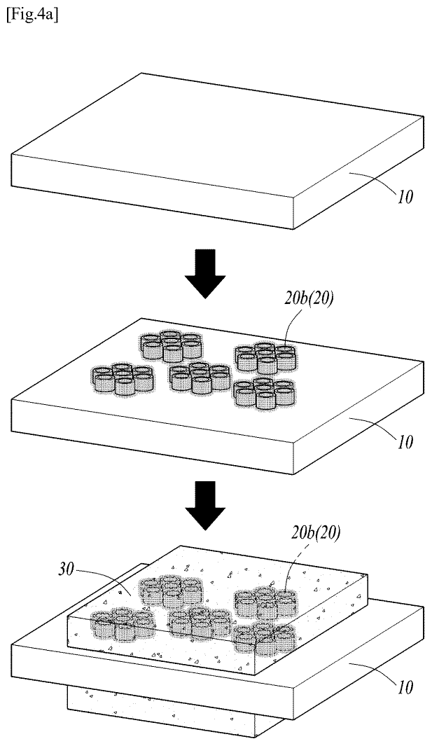

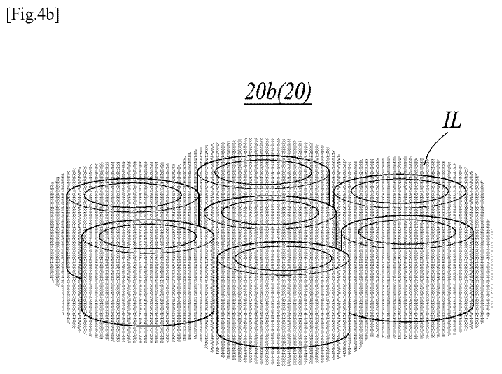

Hereinafter, the configuration of the present disclosure will be described in more detail with reference to FIGS. 1 to 4b. FIG. 1 is a schematic view illustrating a method for manufacturing a membrane-electrode assembly according to an embodiment of the present disclosure. FIG. 2a is a schematic view illustrating a method for manufacturing a membrane-electrode assembly according to another embodiment of the present disclosure, and FIG. 2b is a view illustrating platelet mesoporous carbon having an ionomer layer of FIG. 2a coated on a surface thereof. FIG. 3 is a schematic view illustrating a method for manufacturing a membrane-electrode assembly according to still another embodiment of the present disclosure. FIG. 4a is a schematic view illustrating a method for manufacturing a membrane-electrode assembly according to yet another embodiment of the present disclosure, and FIG. 4b is a view illustrating platelet mesoporous carbon having an ionomer layer of FIG. 4a coated on a surface thereof.

### 1. Membrane-Electrode Assembly and Manufacturing Method Thereof

Referring to FIGS. 1 to 4b, a membrane-electrode assembly 100 according to the present disclosure includes a polymer electrolyte membrane 10. The polymer electrolyte membrane 10 is a commercially available polymer electrolyte membrane well-known in the relevant technical field and may include, for example, an ion conductor.

The first catalyst layer 20 according to the present disclosure may be disposed on at least one surface of the polymer electrolyte membrane 10, and the first catalyst layer 20 may include platelet mesoporous carbon having nanopores oriented orthogonal to an in-plane direction of the polymer electrolyte membrane. That is, a first catalyst layer 20 according to an embodiment of the present disclosure may be disposed only on a first surface of the polymer electrolyte membrane 10, and a commercially available catalyst layer may be disposed on a second surface opposite to the first surface. A first catalyst layer 20 according to another embodiment of the present disclosure may be disposed on each of opposite surfaces of the polymer electrolyte membrane 10. Conventionally, metal nanoparticles (or metal catalyst particles) supported on a carbon-based carrier are generally used as catalyst materials. However, the problem is that under fuel cell operating conditions, ion transfer occurs along ionomers arranged along the edges of the carrier, resulting in ion transfer paths being formed irregularly, such as being long or discontinuous, which in turn lowers ion conductivity. According to an embodiment of the present disclosure, the first catalyst layer 20 includes platelet mesoporous carbon having mesopores oriented orthogonal to an in-plane direction of the polymer electrolyte membrane and having a large surface area. Using the platelet mesoporous carbon enables mass transfer through channels within the pores and ion transfer through ionomers located in these channels within the pores during fuel cell operation, leading to the formation of regular and relatively short paths for ion transfer. This can lead to improvement of the ionic conductivity and performance, and lead to improvement of the durability of catalyst layers due to the skeleton of platelet mesoporous carbon. Additionally, when metal catalyst particles (or metal nanoparticles) in the pores are utilized by supporting them on the platelet mesoporous carbon, they can be prevented from being easily degraded. Also, the metal nanoparticles supported on the carrier can be prevented from clumping together even during long-term operation of a fuel cell. Furthermore, the catalyst supported within the pores of mesoporous carbon adjacent to the polymer electrolyte membrane can act as a stable radical scavenger, thereby increasing durability.

A first catalyst layer 20 according to an embodiment of the present disclosure may include platelet mesoporous carbon on which metal nanoparticles are not supported.

A first catalyst layer 20 according to another embodiment of the present disclosure may include metal nanoparticles that are embedded in platelet mesoporous carbon 20a, 20b while filling internal pores of the platelet mesoporous carbon.

The metal nanoparticles may be, for example, a platinum-based metal or a non-platinum-based metal. The platinum-based metal may be platinum (Pt) or a platinum-based alloy (Pt-M). The M may include one or two or more selected from the group consisting of palladium (Pd), ruthenium (Ru), iridium (Ir), osmium (Os), gallium (Ga), titanium (Ti), vanadium (V), chromium (Cr), manganese (Mn), iron (Fe), cobalt (Co), nickel (Ni), copper (Cu), silver (Ag), gold (Au), zinc (Zn), tin (Sn), molybdenum (Mo), tungsten (W), lanthanum (La), and rhodium (Rh). The platinum-based alloy (Pt-M) may be selected from the group consisting of Pt—Pd, Pt—Sn, Pt—Mo, Pt—Cr, Pt—W, Pt—Ru, Pt—Ni, Pt—Co, Pt—Y, Pt—Ru—W, Pt—Ru—Ni, Pt—Ru—Mo, Pt—Ru—Rh—Ni, Pt—Ru—Sn—W, Pt—Ru—Ir—Ni, Pt—Co, Pt—Co—Mn, Pt—Co—Ni, Pt—Co—Fe, Pt—Co—Ir, Pt—Co—S, Pt—Co—P, Pt—Fe, Pt—Fe—Ir, Pt—Fe—S, Pt—Fe—P, Pt—Au—Co, Pt—Au—Fe, Pt—Au—Ni, Pt—Ni, Pt—Ni—Ir, Pt—Cr, Pt—Cr—Ir, and a mixture of two or more thereof. The non-platinum-based metal may include at least one selected from the group consisting of palladium (Pd), ruthenium (Ru), iridium (Ir), osmium (Os), and a non-platinum-based alloy. The non-platinum-based alloy may selected from the group consisting of Ir—Fe, Ir—Ru, Ir—Os, Co—Fe, Co—Ru, Co—Os, Rh—Fe, Rh—Ru, Rh—Os, Ir—Ru—Fe, Ir—Ru—Os, Rh—Ru—Fe, Rh—Ru—Os, Fe—N, Fe—P, Co—N, and a mixture of two or more thereof.

The second catalyst layer 30 according to the present disclosure may be disposed on the polymer electrolyte membrane 10. Specifically, the first catalyst layer 20 may be interposed between the polymer electrolyte membrane 10 and the second catalyst layer 30. That is, a part of a second catalyst layer 30 according to an embodiment of the present disclosure may be disposed directly on the polymer electrolyte membrane 10, and the remaining part of the second catalyst layer 30 may be disposed directly on the first catalyst layer 20. According to an embodiment of the present disclosure, the second catalyst layer 30 can improve the chemical and/or mechanical durability of the membrane-electrode assembly through interaction with the first catalyst layer 20.

As illustrated in FIGS. 2b and 4b, according to an embodiment of the present disclosure, an ionomer layer IL may be coated on a surface and pores of the platelet mesoporous carbon 20a, 20b. According to an embodiment of the present disclosure, coating the surface and pores of the platelet mesoporous carbon 20a, 20b with the ionomer layer IL can shorten ion transfer paths, thereby increasing ion conductivity and improving the interfacial adhesion between the polymer electrolyte membrane and electrodes, resulting in improved durability of the membrane-electrode assembly. The ionomer layer IL may have a thickness of 1 to 7 nm (nanometers), specifically 1.5 to 6 nm (nanometers), and more specifically 2 to 5 nm (nanometers). When the thickness of the ionomer layer is less than the above numerical range, the ionic conductivity may decrease, whereas when it exceeds the above numerical range, material transfer may be hindered and additional ion transfer channels other than the pores may be created, resulting in deteriorating performance.

Specifically, the ionomer layer IL may include a first ionomer. The first ionomer may have an equivalent weight (EW) of 600 to 1,200. When the equivalent weight of the first ionomer satisfies the above numerical range, the interfacial adhesion between the polymer electrolyte membrane and the electrodes can be improved, and both the ion conductivity and the catalyst durability can be improved.

The first ionomer may be any one selected from the group consisting of a fluorine-based ionomer, a hydrocarbon-based ionomer, and a mixture thereof.

The fluorine-based ionomer may be, for example, a fluorine-based polymer containing fluorine in the main chain thereof, and may be any one selected from the group consisting of poly(perfluorosulfonic acid), poly(perfluorocarboxylic acid), a copolymer of tetrafluoroethylene and fluoro vinyl ether containing a sulfonic acid group, a polystyrene-graft-ethylene tetrafluoroethylene copolymer, a polystyrene-graft-polytetrafluoroethylene copolymer, and a mixture thereof.

The hydrocarbon-based ionomer may be, for example, any one selected from the group consisting of sulfonated polyimide (S-PI), sulfonated polyarylether sulfone (S-PAES), sulfonated polyetheretherketone (S-PEEK), sulfonated polybenzimidazole (S-PBI), sulfonated polysulfone (S-PSU), sulfonated polystyrene (S-PS), sulfonated polyphosphazene, sulfonated polyquinoxaline, sulfonated polyketone, sulfonated polyphenylene oxide, sulfonated polyether sulfone, sulfonated polyether ketone, sulfonated polyphenylene sulfone, sulfonated polyphenylene sulfide, sulfonated polyphenylene sulfide sulfone, sulfonated polyphenylene sulfide sulfone nitrile, sulfonated polyarylene ether, sulfonated polyarylene ether nitrile, sulfonated polyarylene ether nitrile, sulfonated polyarylene ether sulfone ketone, and a mixture thereof.

In order to coat the surface of the platelet mesoporous carbon with the ionomer layer IL, a homogeneous aqueous-phase mixing method using a homogeneous mixer, a high-pressure disperser, etc. or a method using a resonant acoustic mixer (RAM) may be used. Specifically, the coating may be accomplished by mixing a suspension containing a polymer solution including the first ionomer and the platelet mesoporous carbon in a weight ratio of 1:0.3 to 1:3 using a homogeneous mixer at room temperature, drying the mixture at 60° C. to 100° C. for 3 to 12 hours, and then heat-treating the dried mixture at 110° C. to 150° C. for 30 to 100 minutes. However, the technical idea of the present disclosure is not limited thereto, and various methods for coating an ionomer layer on a surface of platelet mesoporous carbon may be applied.

Referring to FIGS. 1 to 4b, the platelet mesoporous carbon according to the present disclosure may have pores included in nanofibers or nanotubes and extending orthogonal to the in-plane direction of the polymer electrolyte membrane. The nanofibers and the nanotubes may each independently have a height of 50 to 600 nm (nanometers). When the height of the nanofibers and the nanotubes satisfies the above numerical range, the membrane-electrode assembly can be improved in terms of not only durability but also performance due to improved ionic conductivity.

Specifically, the platelet mesoporous carbon 20a in the form in which nanofibers are aligned may have a nanopore size of 2 to 20 nm (nanometers), and the platelet mesoporous carbon 20b in the form in which nanotubes are aligned may have a mesopore size of 2 to 30 nm (nanometers). The platelet mesoporous carbon in which the nanofibers and the nanotubes are in the form of platelets may each independently have a width or length of 100 to 1,500 nm (nanometers), specifically 200 to 1,200 nm (nanometers), and more specifically 300 to 1,000 nm (nanometers).

The first catalyst layer 20 according to the present disclosure has an area of 10% to 70% with respect to the total area of the one surface of the polymer electrolyte membrane 10, specifically 20% to 60%, and more specifically 30% to 50%. When the area of the first catalyst layer 20 is less than the above numerical range, the durability of the catalyst layer may not be sufficiently improved, whereas when it exceeds the above numerical range, the first catalyst layer may act as a barrier layer, causing the problem of the second catalyst layer being easily separated.

The second catalyst layer 30 according to the present disclosure may include a carrier and metal nanoparticles supported on the carrier. The carrier may correspond to, for example, one selected from the group consisting of a carbon-based carrier, porous inorganic oxide, zeolite, and a combination thereof. The carbon-based carrier may be selected from, but is not limited to, the group consisting of, for example, graphite, super P, carbon fiber, carbon sheet, carbon black, Ketjen Black, Denka black, acetylene black, carbon nanotube (CNT), carbon sphere, carbon ribbon, fullerene, activated carbon, carbon nanofiber, carbon nanowire, carbon nanoball, carbon nanohorn, carbon nanocage, carbon nanoring, carbon aerogel, graphene, stabilized carbon, activated carbon, and a combination of at least one thereof. The porous inorganic oxide may correspond to at least one selected from the group consisting of, for example, zirconia, alumina, titania, silica, and ceria. The carrier may have a surface area of equal to or greater than 50 m²/g, and an average particle diameter of 10 to 300 nm (nanometers). When the surface area of the carrier is less than the above numerical range, uniform distribution of metal nanoparticles may not be achieved.

The second catalyst layer 30 according to the present disclosure may have a thickness the same as or different from that of the first catalyst layer 20. This is because when the first catalyst layer 20 is randomly distributed on the one surface of the polymer electrolyte membrane 10, the part of the second catalyst layer 30 fills empty spaces between distributed first catalyst layers 20, while the remaining part of the second catalyst layer 30 is formed directly on the first catalyst layer 20.

According to another embodiment of the present disclosure, the second catalyst layer 30 may have a thickness larger than that of the first catalyst layer 20. This enables the second catalyst layer 30 to be formed not only between the spaces defined between the first catalyst layers 20, but also directly on the first catalyst layer, thereby improving the durability of the membrane-electrode assembly. The first catalyst layer may have a thickness of 50 to 2,000 nm (nanometers), specifically 200 to 1,600 nm (nanometers), and more specifically 400 to 1,200 nm (nanometers). When the thickness of the first catalyst layer 20 satisfies the above numerical range, the durability and performance of the membrane-electrode assembly can be simultaneously improved.

A method for manufacturing the membrane-electrode assembly according to the present disclosure may use a batch type or roll-to-roll type decal transfer method or a direct coating method to form the first catalyst layer on at least one surface of the polymer electrolyte membrane.

A polymer electrolyte membrane 10 according to another embodiment of the present disclosure may be a reinforced composite membrane in which an ion conductor is impregnated into a porous support. The ion conductor may include a second ionomer. The second ionomer may be the same as or different from the first ionomer.

The porous support according to the present disclosure may be a fluorine-based support or a nanoweb support. Specifically, the fluorine-based support may be, for example, expanded polytetrafluoroethylene (e-PTFE), which has a polymer fibril microstructure or a microstructure in which nodes are interconnected via fibrils. Additionally, a film having a polymer fibril microstructure in which no nodes are present may be used as the porous support.

The fluorine-based support may include a perfluorinated polymer. The porous support may correspond to a porous support with higher porosity and higher strength formed by extruding dispersion-polymerized PTFE into a tape in the presence of a lubricant and stretching the resulting material. Additionally, the amorphous content of the PTFE may be increased by heat-treating the e-PTFE at a temperature exceeding the melting point of the PTFE (about 342° C.). An e-PTFE film manufactured using the above method may have micropores having various diameters and have porosity. The e-PTFE film manufactured using the above method may have a porosity of at least 35%, and each of the micropores may have a diameter of about 0.01 to 1 μm.

A nanoweb support according to an embodiment of the present disclosure may be a non-woven fibrous web composed of a plurality of randomly oriented fibers. The non-woven fibrous web refers to a sheet which has a structure of individual fibers or filaments that are interlaid, but not in the same manner as in a woven cloth. The nonwoven fibrous web may be manufactured using a method selected from the group consisting of carding, garneting, air-laying, wet-laying, melt blowing, spun bonding, and stitch bonding. The fiber may include one or more polymer materials. Any material that is generally used as a fiber-forming polymer material may be used, and specifically, a hydrocarbon-based fiber-forming polymer material may be used. For example, the fiber-forming polymer material may include any one selected from the group consisting of polyolefins such as polybutylene, polypropylene, and polyethylene; polyesters such as polyethylene terephthalate and polybutylene terephthalate; polyamides (nylon-6 and nylon-6,6); polyurethane; polybutene; polylactic acid; polyvinyl alcohol; polyphenylene sulfide; polysulfone; a liquid crystalline polymer; polyethylene-co-vinyl acetate; polyacrylonitrile; cyclic polyolefin; polyoxymethylene; a polyolefin-based thermoplastic elastomer; and a combination thereof. However, the technical idea of the present disclosure is not limited thereto.

A nanoweb support according to an embodiment of the present disclosure may be a support in which nanofibers are integrated into the form of a nonwoven cloth including a plurality of pores. As the nanofibers, a hydrocarbon-based polymer, which exhibits high chemical resistance and a hydrophobicity, and thus is prevented from being deformed by moisture in a high-humidity environment, is preferably used. Specifically, the hydrocarbon-based polymer may be selected from the group consisting of nylon, polyimide, polyaramid, polyetherimide, polyacrylonitrile, polyaniline, polyethylene oxide, polyethylene naphthalate, polybutylene terephthalate, styrene-butadiene rubber, polystyrene, polyvinyl chloride, polyvinyl alcohol, polyvinylidene fluoride, polyvinyl butylene, polyurethane, polybenzoxazole, polybenzimidazole, polyamide imide, polyethylene terephthalate, polyphenylene sulfide, polyethylene, polypropylene, a copolymer thereof, and a mixture thereof. Of these, polyimide, which exhibits higher thermal resistance, chemical resistance, and shape stability, is preferably used.

The nanoweb support is an aggregate of nanofibers in which nanofibers manufactured by electrospinning are arranged randomly. At this time, considering the porosity and thickness of the nanoweb, it is preferable for the nanofibers have an average diameter of 40 to 5,000 nm, the average diameter being obtained by measuring the diameters of 50 fibers using a scanning electron microscope (JSM6700F, JEOL) and calculating the average of the diameters. When the average diameter of the nanofibers is less than the above numerical range, the mechanical strength of the porous support may deteriorate, whereas when the average diameter of the nanofibers exceeds the above numerical range, the porosity of the porous support may remarkably deteriorate and the thickness thereof may increase.

The nonwoven fibrous web may have a thickness of 10 to 50 μm (micrometers), specifically 15 to 43 μm (micrometers). When the thickness of the nonwoven fibrous web is less than the above numerical range, the mechanical strength may deteriorate, whereas when it exceeds the above numerical range, the resistance loss may increase, and the weight reduction and integration may decrease. The nonwoven fibrous web may have a basic weight of 5 to 30 mg/cm². When the basis weight of the nonwoven fibrous web is less than the above numerical range, visible pores may be formed in the nonwoven fibrous web, making it difficult to realize the function as the porous support, whereas when it exceeds the above numerical range, the nonwoven fibrous web may be manufactured in the form of a paper or textile in which pores are hardly formed.

The porous support according to the present disclosure may have a porosity of 30% to 90%, preferably 60% to 85%. When the porosity of the porous support is less than the above numerical range, the impregnation property of the ion conductor may deteriorate, whereas when it exceeds the above numerical range, the shape stability of the porous support may deteriorate, making it difficult for subsequent processes to proceed smoothly. The porosity may be calculated using Mathematical Equation 1 below based on the ratio of the volume of air in the porous support to the total volume of the porous support. At this time, the total volume may be calculated by manufacturing a rectangular sample and measuring the width, length, and thickness of the sample, and the volume of air may be obtained by subtracting the volume of a polymer, back-calculated from the density thereof after measuring the mass of the sample, from the total volume of the porous support.

$$[ Mathematical Equation 1 ]$$

$$Porosity ( \% ) = ( volume of air in porous support / total volume of porous support ) \times 100$$

### 2. Fuel Cell

Another embodiment of the present disclosure provides a fuel cell including the membrane-electrode assembly.

FIG. 5 is a schematic view illustrating a fuel cell according to an embodiment of the present disclosure.

Referring to FIG. 5, the fuel cell 200 according to the present disclosure includes a fuel supply unit 210 that supplies a mixed fuel in which fuel and water are mixed, a reforming unit 220 that reforms the mixed fuel to generate a reformed gas containing hydrogen gas, a stack 230 that generates electrical energy by causing an electrochemical reaction between the hydrogen gas-containing reformed gas supplied from the reforming unit 220 and an oxidizing agent, and an oxidizing agent supply unit 240 that supplies the oxidizing agent to the reforming unit 220 and the stack 230.

The stack 230 includes a plurality of unit cells that generate electrical energy by inducing an oxidation/reduction reaction between the hydrogen gas-containing reformed gas supplied from the reforming unit 220 and the oxidizing agent supplied from the oxidizing agent supply unit 240.

Each of the unit cells refers to a unit cell that generates electricity, and includes the membrane-electrode assembly that oxidizes/reduces the hydrogen gas-containing reformed gas and oxygen in the oxidizing agent, and separators (also referred to as bipolar plates, hereinafter referred to as “separators”) that supply the hydrogen gas-containing reformed gas and the oxidizing agent to the membrane-electrode assembly. The separators are disposed on opposite sides of the membrane-electrode assembly. At this time, the separators located at the outermost sides of the stack may be particularly referred to as end plates.

Among the separators, one of the end plates is provided with a pipe-shaped first supply tube 231 for injecting the hydrogen gas-containing reformed gas supplied from the reforming unit 220, and a pipe-shaped second supply tube 232 for injecting oxygen gas, and the remaining end plate is provided with a first discharge tube 233 for discharging the hydrogen gas-containing reformed gas that finally remains unreacted in the plurality of unit cells to the outside, and a second discharge tube 234 for discharging the oxidizing agent that finally remains unreacted in the unit cells to the outside.

In the above fuel cell, the separators constituting an electricity generation unit, the fuel supply unit, and the oxidizing agent supply unit are those used in a typical fuel cell, and therefore, a detailed description thereof is omitted in this specification.

Hereinbelow, each configuration of the present disclosure will be described in detail such that the present disclosure can be easily embodied by one of ordinary skill in the art to which this disclosure belongs, but this is merely one example, and the scope of the present disclosure is not limited thereto.

### Synthesis Example 1: Synthesis of Platelet Mesoporous Silica

To synthesize platelet mesoporous silica to be used as a template, ZrOCl₂·8H₂O (0.32 g) and poly(ethylene glycol)-block-poly(propylene glycol)-block-poly(ethylene glycol) (Pluronic P123; 2.0 g) were dissolved in 2.0 M HCl aqueous solution, and 4.2 g of tetraethylorthosilicate (TEOS) was added, followed by hydrolysis at 35° C. for 30 minutes. 1.0 g of TMB (trimethylbenzene) was added to the mixed solution in which the hydrolysis occurred, and the solution was subjected to hydrolysis and condensation polymerization at 35° C. for 12 hours. After hydrothermally treating the solution at 90° C. for 5 hours, the resulting product was sequentially filtered, dried, and calcined at 550° C. for 6 hours. Thus, platelet mesoporous silica was synthesized.

### Synthesis Example 2: Synthesis of Conventional (Non-Platelet) Mesoporous Silica

To synthesize conventional mesoporous silica to be used as a template, poly(ethylene glycol)-block-poly(propylene glycol)-block-poly(ethylene glycol) (Pluronic P123; 2.0 g) was dissolved in a 2.0 M HCl aqueous solution, and 4.2 g of tetraethylorthosilicate (TEOS) was added, followed by hydrolysis and condensation polymerization at 35° C. for 12 hours. Afterwards, the resulting product was filtered, dried, and sintered at 550° C. for 6 hours. Thus, non-platelet mesoporous silica was synthesized.

### Preparation Example 1-1: Preparation of Platelet Mesoporous Carbon in the Form in which Nanofibers are Vertically Aligned

1.0 g of platelet mesoporous silica (length 700 nm, height 300 nm, mesopores 10 nm) prepared through Synthesis Example 1 above was used as a template. After filling the mesopores with phenol formaldehyde resin (phenolic resin 0.6 g) as a polymer precursor, a polymerization reaction was performed at 140° C., and then carbonization was performed at 1,000° C. under inert gas conditions. Afterwards, the template was removed to finally prepare platelet mesoporous carbon in the form in which nanofibers with a length of 700 nm and a height of 300 nm were aligned, with mesopores with an average size of 6 nm present between the nanofibers.

### Preparation Example 1-2: Preparation of Platelet Mesoporous Carbon in the Form in which Nanofibers Coated with Ionomer Layer on Surface and Pores are Vertically Aligned

A suspension was prepared by homogeneously mixing platelet mesoporous carbon prepared according to Preparation Example 1-1 and perfluorosulfonic acid (PFSA) having an equivalent weight of 800 in a weight ratio of 1:1 using a high shear mixer. The suspension was dried at 90° C. for 10 hours and then heat-treated at 130° C. for 60 minutes. Thus, an ionomer layer with a thickness of 3.5 nm was formed on a surface and pores of the platelet mesoporous carbon.

### Preparation Example 2-1: Preparation of Platelet Mesoporous Carbon in the Form in which Nanotubes are Vertically Aligned

1.0 g of platelet mesoporous silica (length 700 nm, height 300 nm, mesopores 10 nm) prepared through Synthesis Example 1 was acid-treated using AlCl₃ to prepare an acid-treated template. By using the acid-treated template, the same procedure was carried out as in Preparation Example 1-1 to finally prepare platelet mesoporous carbon in the form in which nanotubes with an average pore size of 8 nm, a width of 400 nm, a length of 700 nm, and a height of 300 nm were aligned, with mesopores with an average size of 6 nm present between the nanotubes.

### Preparation Example 2-2: Preparation of Platelet Mesoporous Carbon in the Form in which Nanotubes Coated with Ionomer Layer on Surface and Pores are Aligned

Except for using platelet mesoporous carbon prepared according to Preparation Example 2-1, the same procedure was carried out as in Preparation Example 1-2 to form an ionomer layer with a thickness of 3.5 nm on a surface and pores of platelet mesoporous carbon.

### Preparation Example 3: Preparation of Catalyst Having Metal Catalyst Particles Supported in Pores of Platelet Mesoporous Carbon

A platinum precursor was injected into pores of platelet mesoporous carbon synthesized according to Preparation Example 1-1, and then reduced. Thus, a catalyst in which 50% Pt was supported in the pores of the platelet mesoporous carbon was prepared.

### Preparation Example 4: Preparation of Conventional (Non-Platelet) Mesoporous Carbon

By using 1.0 g of conventional mesoporous silica (length 700 nm, height 800 nm, mesopores 7 nm) prepared through Synthesis Example 2 as a template, the same procedure was carried out as in Preparation Example 1-1 to finally prepare conventional mesoporous carbon having mesopores with a length of 700 nm, a height of 800 nm, and an average size of 5 nm.

### Experimental Example 1: UHR-SEM Image of Platelet Mesoporous Carbon According to Preparation Example 1-1

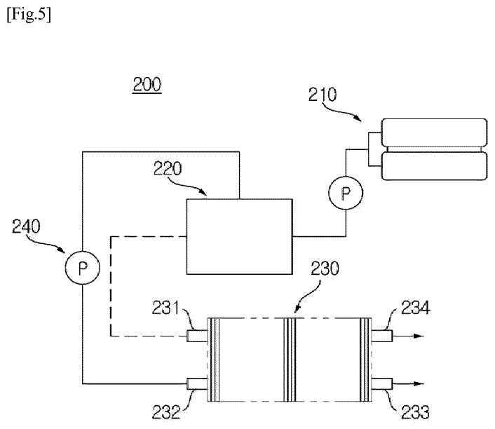

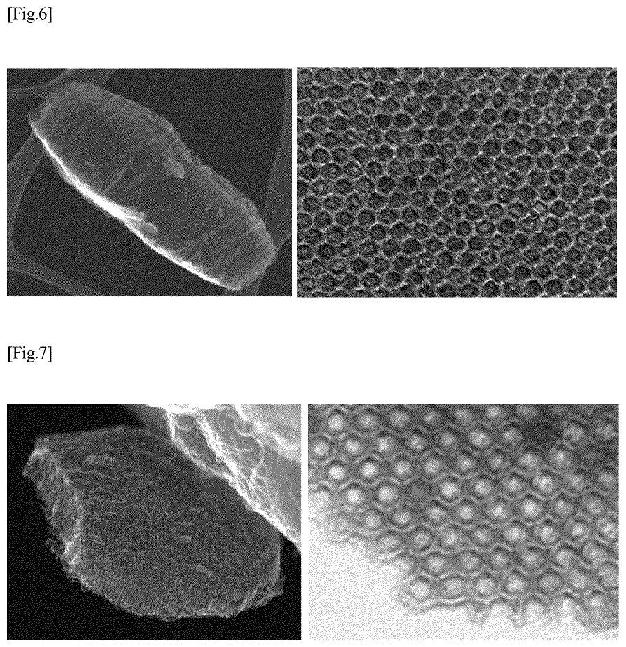

FIG. 6 is a view illustrating ultra high resolution-scanning electron microscope (UHR-SEM) images of platelet mesoporous carbon in the form in which nanofibers are aligned according to Preparation Example 1-1.

Referring to FIG. 6, a first catalyst layer was formed using platelet mesoporous carbon in the form in which nanofibers were aligned according to Preparation Example 1-1.

### Experimental Example 2: UHR-SEM Image of Platelet Mesoporous Carbon According to Preparation Example 2-1

FIG. 7 is a view illustrating ultra high resolution-scanning electron microscope (UHR-SEM) images of platelet mesoporous carbon in the form in which nanotubes are aligned according to Preparation Example 2-1.

Referring to FIG. 7, a first catalyst layer was formed using platelet mesoporous carbon in the form in which nanotubes were aligned according to Preparation Example 2-1.

### Preparation Example 5: Manufacturing of Membrane-Electrode Assembly

### Example 1-1: Manufacturing of Membrane-Electrode Assembly to which Platelet Mesoporous Carbon According to Preparation Example 1-1 is Applied

### Step (a): Manufacturing Polymer Electrolyte Membrane

A polymer solution in which a solvent of water and isopropanol in a weight ratio of 1:1 and perfluorosulfonic acid were mixed was applied to a glass substrate using a doctor blade, and the applied polymer solution was slowly heated to 80° C. and then dried for 4 hours. Thus, a polymer electrolyte membrane was manufactured.

### Step (b): Forming First Catalyst Layer

An electrode slurry in which platelet mesoporous carbon of Preparation Example 1-1 and a binder (EW800) were mixed in a weight ratio of 1:1.5 was randomly applied using a spraying method or slot die method. Thus, a first catalyst layer with a thickness of 900 nm was formed.

### Step (c): Forming Second Catalyst Layer

Thereafter, an electrode slurry in which a commercially available Pt/C catalyst (Tanaka Corporation) and a binder (EW=800) were mixed in a weight ratio of 1:0.5 was directly coated on one surface of the polymer electrolyte membrane. Thus, a second catalyst layer with a maximum thickness of 15 μm was formed. As a result of forming the second catalyst, the first catalyst layer was interposed between the polymer electrolyte membrane and the second catalyst layer.

### Example 1-2: Manufacturing of Membrane-Electrode Assembly to which Platelet Mesoporous Carbon Coated with Ionomer Layer on Surface and Pores According to Preparation Example 1-2 is Applied

Except for using platelet mesoporous carbon coated with an ionomer layer according to Preparation Example 1-2 instead of platelet mesoporous carbon according to Preparation Example 1-1, the same procedure was carried out as in Preparation Example 1-1 to manufacture a membrane-electrode assembly.

### Example 2-1: Manufacturing of Membrane-Electrode Assembly to which Platelet Mesoporous Carbon According to Preparation Example 2-1 is Applied

Except for Using Platelet Mesoporous Carbon According to Preparation Example 2-1 Instead of Platelet Mesoporous Carbon According to Preparation Example 1-1, the Same Procedure was Carried Out as in Preparation Example 1-1 to Manufacture a membrane-electrode assembly.

### Example 2-2: Manufacturing of Membrane-Electrode Assembly to which Platelet Mesoporous Carbon Coated with Ionomer Layer on Surface and Pores According to Preparation Example 2-2 is Applied

Except for using platelet mesoporous carbon coated with an ionomer layer according to Preparation Example 2-2 instead of platelet mesoporous carbon coated with an ionomer layer according to Preparation Example 1-2, the same procedure was carried out as in Preparation Example 1-2 to manufacture a membrane-electrode assembly.

### Example 3: Manufacturing of Membrane-Electrode Assembly to which Catalyst Having Metal Catalyst Particles Supported in Pores of Platelet Mesoporous Carbon According to Preparation Example 3 is Applied

Except for using a catalyst supported on mesoporous carbon according to Preparation Example 3 instead of platelet mesoporous carbon according to Preparation Example 1-1, the same procedure was carried out as in Preparation Example 1-1 to manufacture a membrane-electrode assembly.

### Comparative Example 1: Membrane-Electrode Assembly to which Conventional (Non-Platelet) Mesoporous Carbon is Applied

Except for using non-platelet mesoporous carbon according to Preparation Example 4 instead of platelet mesoporous carbon according to Preparation Example 1-1, the same procedure was carried out as in Preparation Example 1-1 to manufacture a membrane-electrode assembly.

### Experimental Example 3: SEM Cross-Sectional Image of Membrane-Electrode Assembly Including Platelet Mesoporous Carbon Layer According to Example 2-2

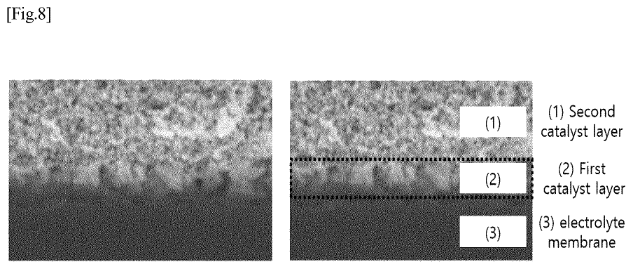

FIG. 8 is a view illustrating SEM cross-sectional images of a membrane-electrode assembly including platelet mesoporous carbon in the form in which nanotubes are aligned according to Example 2-2.

Referring to FIG. 8, a first catalyst layer was formed using platelet mesoporous carbon in the form in which nanotubes were aligned according to Preparation Example 2-2, and then a second catalyst layer was formed.

### Experimental Example 4: Performance Evaluation of Membrane-Electrode Assembly

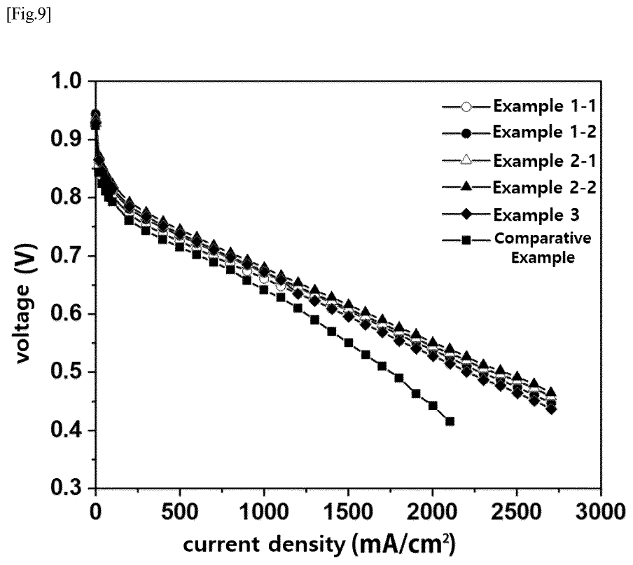

FIG. 9 is a view illustrating the performance evaluation results of membrane-electrode assemblies manufactured by Examples and Comparative Example under conditions of 80° C., 100% RH, and normal pressure. Specifically, a fuel cell evaluation station was used to evaluate the performance of the membrane-electrode assemblies

Referring to FIG. 9, the membrane-electrode assemblies according to Examples exhibited improved performance compared to Comparative Example.

### Experimental Example 5: Mechanical Durability Evaluation of Membrane-Electrode Assembly

To evaluate the mechanical durability of the membrane-electrode assemblies according to Examples and Comparative Example, the U.S. Department of Energy (DOE) protocol for mechanical durability evaluation was used.
Evaluation conditions: To evaluate the mechanical durability of the membrane-electrode assemblies, wet-dry cycles were performed for 20,000 cycles under repeated 2-minute wet-2-minute dry cycles at 80° C. and Air/Air conditions, and then hydrogen crossover (H₂ crossover) was measured.

TABLE 1

| | Sample | | | | | |
|---|---|---|---|---|---|---|
| | Comparative | Exam- | Exam- | Exam- | Exam- | Exam- |
| | Example 1 | ple 1-1 | ple 1-2 | ple 2-1 | ple 2-2 | ple 3 |
| Hydrogen | 10.3 | 3.7 | 3.3 | 3.5 | 3.0 | 3.6 |
| crossover | | | | | | |
| (ppm) | | | | | | |
| @20,000 | | | | | | |
| cycles) | | | | | | |

Referring to Table 1 above, it can be seen that as a result of measuring the amount of hydrogen at a cathode electrode, the amount of hydrogen passing through a polymer electrolyte membrane in Examples was significantly less than that in Comparative Example. According to an embodiment of the present disclosure, it can be inferred that the durability of the membrane-electrode assembly is significantly improved, thereby achieving improved performance and prolonged lifespan of the fuel cell.

Although the preferred embodiments of the present disclosure have been described in detail above, the scope of the present disclosure is not limited thereto, and it will be understood by those skilled in the art that various changes and modifications may be made therein without departing from the spirit and scope of the present disclosure as defined by the appended claims.

### DESCRIPTION OF THE REFERENCE NUMERALS IN THE DRAWINGS

10: polymer electrolyte membrane
20: first catalyst layer
30: second catalyst layer
100: membrane-electrode assembly
IL: ionomer layer

1. A membrane-electrode assembly, comprising:
a polymer electrolyte membrane;
a first catalyst layer disposed on at least one surface of the polymer electrolyte membrane; and
a second catalyst layer disposed on the polymer electrolyte membrane,
wherein the first catalyst layer is interposed between the polymer electrolyte membrane and the second catalyst layer, and
the first catalyst layer includes platelet mesoporous carbon.

2. The membrane-electrode assembly of claim 1, wherein an ionomer layer is coated on a surface and pores of the platelet mesoporous carbon.

3. The membrane-electrode assembly of claim 2, wherein the ionomer layer includes a first ionomer, and
the first ionomer has an equivalent weight (EW) of 600 to 1,200.

4. The membrane-electrode assembly of claim 3, wherein the first ionomer is any one selected from the group consisting of a fluorine-based ionomer, a hydrocarbon-based ionomer, and a mixture thereof.

5. The membrane-electrode assembly of claim 1, wherein the platelet mesoporous carbon is in the form in which nanofibers or nanotubes are aligned, and
pores included in the nanofibers or nanotubes extend orthogonal to an in-plane direction of the polymer electrolyte membrane.

6. The membrane-electrode assembly of claim 5, wherein the nanofibers and the nanotubes each independently have a height of 50 to 600 nm.

7. The membrane-electrode assembly of claim 1, wherein the first catalyst layer has an area of 10% to 70% with respect to the total area of the one surface of the polymer electrolyte membrane.

8. The membrane-electrode assembly of claim 1, wherein the second catalyst layer has a thickness the same as or different from that of the first catalyst layer.

9. The membrane-electrode assembly of claim 8, wherein the second catalyst layer has a thickness larger than that of the first catalyst layer.

10. The membrane-electrode assembly of claim 9, wherein the first catalyst layer has a thickness of 50 to 2,000 nm.

11. A fuel cell comprising the membrane-electrode assembly of claim 1.
